(19) United States
(12) Patent Application Publication
(10) Pub. No.: US 2025/0191127 A1
(43) Pub. Date: Jun. 12, 2025

(54) DETECTING FLANGE ANOMALIES USING IMAGE DATA FUSION

(71) Applicant: Saudi Arabian Oil Company, Dhahran (SA)

(72) Inventors: Sahejad Patel, Thuwal (SA); Hamad Alsaiari, Al-Khobar (SA); Hassane Trigui, Jeddah (AS); Frankly Leonardo Toro Gonzalez, Thuwal (SA); Siddharth Mishra, Dhahran (SA)

(21) Appl. No.: 18/531,060

(22) Filed: Dec. 6, 2023

(51) Int. Cl. G06T 5/50; G01J 5/00; G01J 5/48; G06V 10/25; G06V 10/44; G06V 10/764

(52) U.S. Cl. CPC G06T 5/50; G01J 5/48; G06V 10/25; G06V 10/44; G06V 10/764; G01J 2005/0077; G06T 2207/20081; G06T 2207/20221; G06V 2201/07

(57) ABSTRACT

Example methods and systems for detecting flange anomalies using image data fusion are disclosed. One example method includes obtaining one or more RGB images and one or more thermal images of a flange. The one or more RGB images and the one or more thermal images are processed to generate a fused image data set. The fused image data set is provided as input to a first machine learning (ML) model that is trained to detect one or more anomaly types of flanges. One or more anomalies of the flange are determined using the first ML model. The determined one or more anomalies of the flange are provided for maintenance of the flange.

### TECHNICAL FIELD

The present disclosure relates to computer-implemented methods and systems for detecting flange anomalies using image data fusion.

### BACKGROUND

Flanges can include projecting collars that are physically coupled to seal a pressurized vessel or pipe. Multiple flanges can be used in a pipeline. Standards applicable to flanges are promulgated by organizations such as the American Society of Mechanical Engineers (ASME) and American National Standards Institute (ANSI).

Flange integrity assessment methods can be physical in nature and can require trained operators to interact with a flange to detect anomalies, for example, missing parts of the flange, flange misalignments, leaks, moisture, scales, and/or corrosion of the flange, as well as abnormal gasket conditions.

### SUMMARY

The present disclosure involves methods and systems for detecting flange anomalies using image data fusion. One example method includes obtaining one or more RGB images and one or more thermal images of a flange. The one or more RGB images and the one or more thermal images are processed to generate a fused image data set. The fused image data set is provided as input to a first machine learning (ML) model that is trained to detect one or more anomaly types of flanges. One or more anomalies of the flange are determined using the first ML model. The determined one or more anomalies of the flange are provided for maintenance of the flange.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, processing the one or more RGB images and the one or more thermal images to generate the fused image data set includes aligning one of the one or more RGB images with one of the one or more thermal images to a common coordinate system.

In some implementations, determining the one or more anomalies of the flange includes determining one or more backbone models in the first ML model based on the one or more anomaly types of the flange.

In some implementations, the one or more backbone models include at least one backbone model for object detection, image classification, instance segmentation, or regression.

In some implementations, the one or more anomaly types of the flange include at least one of missing parts in the flange, misaligned faces of the flange, or external corrosion of the flange.

In some implementations, before determining the one or more anomalies of the flange using the first ML model, training the first ML model using multiple RGB images and multiple thermal images of multiple flanges.

In some implementations, training the first ML model using the multiple RGB images and the multiple thermal images of the multiple flanges includes extracting, using a second ML model, one or more features from the multiple RGB images and the multiple thermal images; generating a fused training image data set using the extracted one or more features; and training the first ML model based on the fused training image data set.

In some implementations, an output of the first ML model includes at least one of one or more classification labels for the one or more anomaly types of the flange, one or more regression values for estimating a flange size, a bolt length, or a flange misalignment inclination, one or more object detection bounding boxes, or one or more segmentation masks for areas with anomalies.

In some implementations, the maintenance of the flange includes at least one of replacing the flange, installing missing parts of the flange, adjusting an alignment between faces of the flange, or repairing the flange to prevent leakage from the flange.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A illustrates an example anomaly detection system, according to some implementations.

FIG. 1B illustrates example images of flanges obtained using a forward-looking Infrared (FLIR) thermal camera, according to some implementations.

FIG. 2 illustrates an example process of asset anomaly detection using RGB images and thermal images, according to some implementations.

FIG. 3 illustrates an example process for detecting asset anomalies, according to some implementations.

FIG. 4 is a block diagram of an example computer system that can be used to provide computational functionalities associated with described algorithms, methods, functions, processes, flows, and procedures, according to some implementations of the present disclosure.

FIG. 5 illustrates hydrocarbon production operations that include both one or more field operations and one or more computational operations, which exchange information and control exploration for the production of hydrocarbons, according to some implementations.

Like reference numbers and designations in the various drawings indicate like elements.

### DETAILED DESCRIPTION

Flanges enable connections between pipes of pipeline systems that transport various materials, such as oil, gas, water, and the like. Additionally, flanges can securely seal pressurized vessels that store various materials. A flange can include two flange collars bolted together using a set of bolts mated with corresponding nuts. A seal is created between the flange collars, enabling a strong joint or connection between two pipes. Ensuring the integrity of flanges is vital to maintaining a safe pipeline or pressurized vessel. In some cases, inspections of flanges in the field are conducted infrequently, since traditional inspections require that a trained operator travel to the pipeline and visually inspect the flanges. Additionally, some existing anomaly detection systems use red-green-blue (RGB) image data to inspect and identify anomalies in flanges.

Although RGB cameras offer color images that can be interpreted by a human observer or algorithms, this approach has many limitations. For example, detection capabilities of a system relying only on RGB images include viewpoint sensitivity due to flange geometry awareness, noisy backgrounds, and/or different lightning conditions.

This disclosure describes systems and methods that use multiple image data sources, for example, red-green-blue (RGB) image data and thermal image data, to inspect assets, for example, flanges, and detect anomalies such as missing parts, flange misalignments, and/or abnormal gasket conditions associated with flanges. In some implementations, the disclosed methods and systems can also be used to detect leaks, moisture, scales, and/or corrosion of flanges.

The disclosed systems and methods provide many advantages over existing systems. As an example, the disclosed systems and methods can lead to reduced time for flange inspection when compared to manual process of inspecting flanges. As another example, the disclosed systems and methods can result in less training for flange inspection and integrity assessment for computer-based anomaly detection. Consequently, the disclosed systems and methods can lead to lower costs (e.g., processing and/or economic costs) for flange inspection when compared to the existing manual processes of inspecting flanges. Further, the disclosed systems and methods can improve processing and workflow efficiency as compared to existing systems that are encumbered by manual workflows. Additionally, the disclosed systems and methods can leverage historical image data of flanges from thermal sensors and RGB cameras for detecting flange anomalies.

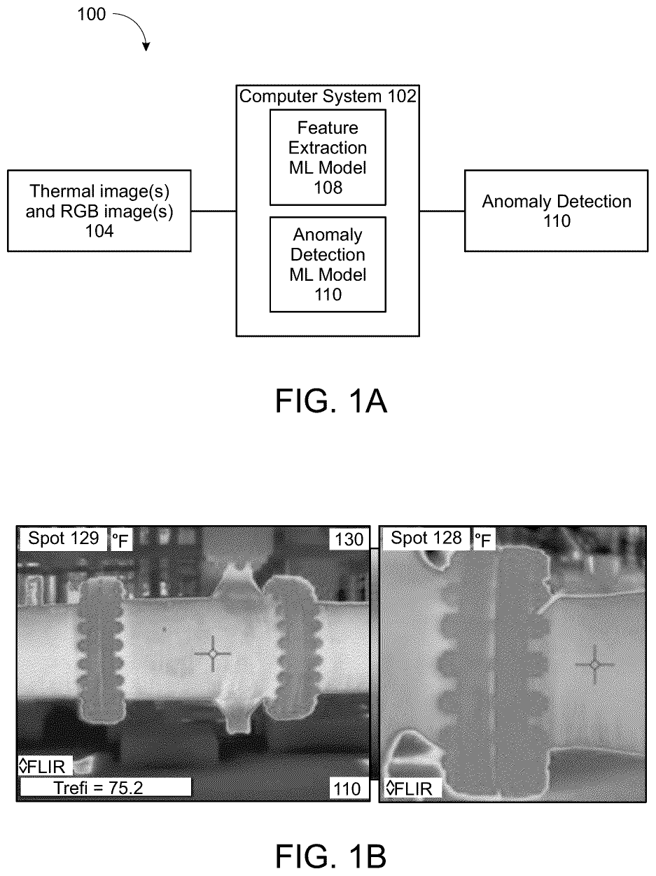

FIG. 1A illustrates an example anomaly detection system 100, according to some implementations. As shown in FIG. 1A, a computer system 102 of the anomaly detection system 100 receives as input 104 one or more thermal images and one or more RGB images of an asset, e.g., a flange. As also shown in FIG. 1A, the anomaly detection system 100 provides as output 106 identification of anomalies in the asset (if any). Computer system 102 can include feature extraction machine learning (ML) model 108 and anomaly detection ML model 110. Computer system 102 can use only the feature extraction part of feature extraction ML model 108 to extract features from the one or more thermal images and one or more RGB images of the asset to create a feature set for the asset. Computer system 102 can then use the created feature set and the one or more thermal images and one or more RGB images of the asset as input to anomaly detection ML model 110 to identify anomalies in the asset as output 106. Computer system 102 can use the created feature set to handle different conditions in the one or more thermal images and one or more RGB images of the asset, when using anomaly detection ML model 110 to identify anomalies in the asset. In some implementations, anomaly detection ML model 110 can be a deep learning (DL) neural network. In some implementations, computer system 102 can combine feature extraction ML model 108 and anomaly detection ML model 110 sequentially for an end-to-end machining learning based implementation to identify anomalies in the asset.

In some implementations, before using feature extraction ML model 108 and anomaly detection ML model 110 for anomaly detection and/or integrity assessment of an asset, for example, a flange, computer system 102 can use historical RGB images and thermal images of assets of the same type to train feature extraction ML model 108 and anomaly detection ML model 110. Computer system 102 can first process the historical RGB images and thermal images, then use the processed historical RGB images and thermal images to train feature extraction ML model 108 and anomaly detection ML model 110. In some implementations, computer system 102 can use the output of feature extraction ML model 108 to generate fused training image data set associated with the historical RGB images and thermal images, then train anomaly detection ML model 110 using the fused training image data set.

FIG. 1B illustrates example images of flanges obtained using a forward-looking Infrared (FLIR) thermal camera. The sensing capability of a thermal infrared sensor is independent of lighting conditions, as thermal infrared sensors can operate based on thermal radiation, independent of any light source.

In some implementations, the computer system 102 can use a combination of flange images from one or more thermal cameras and one or more RGB cameras for the same view/perspective to detect and classify flange anomalies using anomaly detection ML model 110. Each flange anomaly can be predicted using individual models in the ML model. The computer system can utilize the extra features that thermal images can provide to handle noisy backgrounds and different lighting conditions, as well as increased geometry awareness from the thermal images to enhance the performance of detection anomalies of a flange.

In some implementations, the output of anomaly detection ML model 110 can be used for object detection of missing flange parts, anomaly detection of a flange, and/or overall flange health classification. The output of anomaly detection ML model 110 can also include regression values used to estimate the flange size, bolt length, and/or flange misalignment inclination.

In some implementations, the type of network used in feature extraction ML model 108 or anomaly detection ML model 110 can be flexible. For example, convolution neural networks (CNNs) or similar architectures can be used for the development of feature extraction ML model 108 or anomaly detection ML model 110.

In some implementations, computer system 102 can manage, fuse, and extract features using RGB images and thermal images of an asset, for example, a flange, and output information that can be used for anomaly detection of the asset.

In some implementations, the detected anomalies of the asset can be used to facilitate asset surveying process and/or support the maintenance of the asset. For example, detected missing parts of flanges can be replaced. Flanges with detected leakage can be repaired or replaced. Faces of flanges with detected misaligned flange faces can be aligned. Flanges with detected corrosion can be repaired or replaced. Detected defective gaskets of flanges can be replaced.

In some implementations, the anomaly detection system 100 can be used for integrity assessment of assets that involves visual inspection and analysis. For example, fluid (e.g., oil) lubrication levels in equipment can be monitored by operators through a sight glass. But the sight glass can get dirty and an RGB image alone might not be adequate to measure the fluid lubrication level accurately. Combining the RGB and thermal images of the fluid can help better monitor the fluid lubrication levels. Other examples can include detecting anomalies related to motor windings, fin fans, and/or structures around equipment, using a combination of RGB images and thermal images.

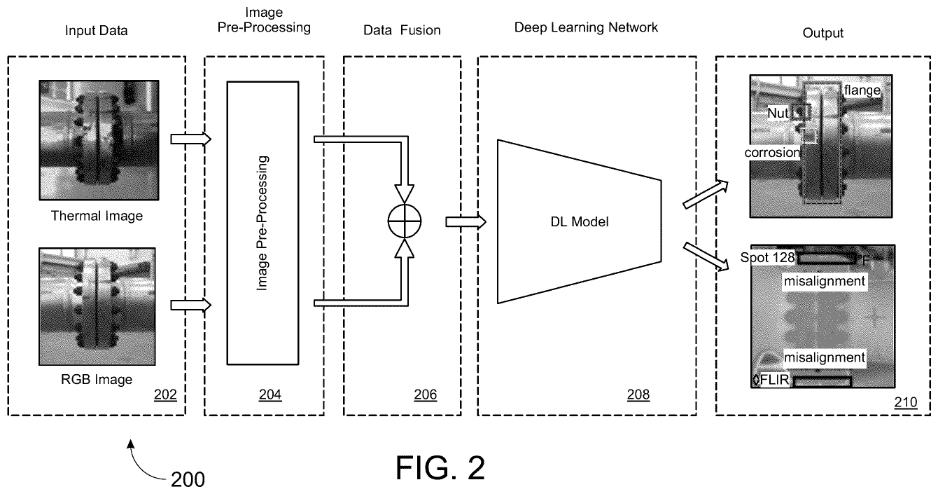

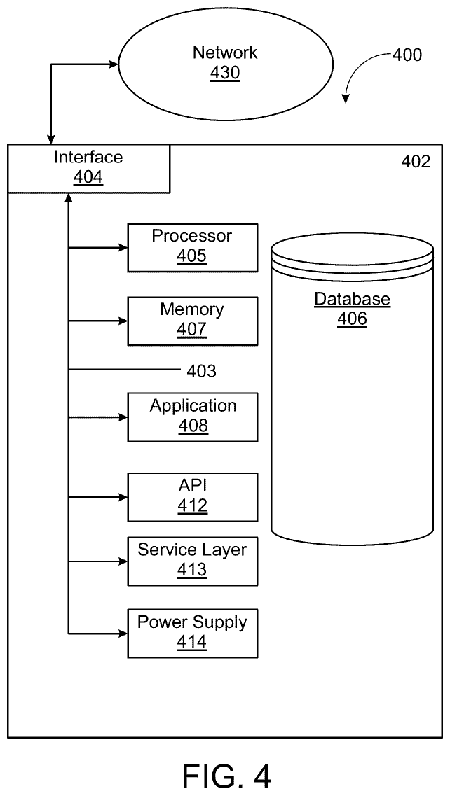

FIG. 2 illustrate an example process 200 of asset anomaly detection using RGB images and thermal images. For convenience, process 200 will be described as being performed by a system of one or more computers, located in one or more locations, and programmed appropriately in accordance with this specification (e.g., the computer system 102 of FIG. 1 or the computer system 400 of FIG. 4).

At 202, a computer system obtains one or more thermal images and one or more RGB images of a target flange that is under assessment.

In some implementations, a thermal camera sensor can take a thermal image of the target flange focusing on an area of interest. The area of interest can depend on the decision of interest or the desired output of the process 200. As an example, if the decision of interest is misalignment detection, the area of interest can be either the top or bottom part of the flange. As another example, if the decision of interest is flange overall integrity, then the area of interest is the whole flange.

In some implementations, an RGB camera sensor can take an RGB image of the flange that focuses on the same area of interest that the thermal camera sensor focuses on.

At 204, the computer system pre-processes the one or more thermal images and the one or more RGB images obtained at 202. In some implementations, the computer system can pre-preprocess the RGB and thermal images such that they focus on the same area of interest in the flange. The computer system can align the RGB images with the thermal images of the same area of interest to a common coordinate system, using image processing methods, for example, image registration methods, before fusing the RGB images with the thermal images. In some examples, the computer system can use machine learning techniques to align RGB and thermal images by learning the relevant alignment process.

In some implementations, the computer system can enhance a thermal image of the flange by increasing its resolution and/or matching its resolution to the resolution of an RGB image of the same area of interest in the flange, by using image registration methods, such as, homography-based image registration methods.

In some implementations, thermal cameras, for example, forward-looking InfraRed (FLIR) cameras, can provide both thermal and RGB images of the same view. A computer system can use the thermal and RGB images of an asset provided by FLIR cameras to detect anomalies in the same type of asset.

At 206, the computer system can combine the RGB images and thermal images pre-processed at 204 before feeding the images to an anomaly detection ML model, for example, the deep learning network in 208, for anomaly detection and/or integrity assessment of assets such as flanges. An example of the anomaly detection ML model is anomaly detection ML model 110 in FIG. 1.

In some implementations, the computer system fuses the RGB images and thermal images pre-processed at 204 using computer vision techniques such as image blending and/or overlay methods.

In some implementations, the computer system fuses the RGB images and thermal images pre-processed at 204 using techniques such as feature engineering. The computer system can use only the feature extraction part of a feature extraction ML model (different from the anomaly detection ML model used in 208) to extract features from the RGB images and thermal images to create an enhanced feature set. An example of the feature extraction ML model is feature extraction ML model 108 in FIG. 1. Example features extracted by the feature extraction ML model can include flange geometry features from the RGB images and background information features from the thermal images. The computer system can feed the enhanced feature set into an ML model, for example, the deep learning network described in 208, to handle different conditions in the RGB images and/or the thermal images, for example, noisy backgrounds in the RGB images or the thermal images, or different lighting conditions in the RGB images.

In some implementations, the computer system can process separately the RGB images and thermal images pre-processed at 204, then feed the processed RGB images and thermal images into an anomaly detection ML model, for example, the deep learning network in 208, for anomaly detection. Example processing methods can include image enhancement and/or correction method applied to each RGB image and thermal image by the computer system.

At 208, the computer system can use the RGB images and thermal images fused and/or processed at 206 as the input to an anomaly detection ML model, for example, a deep learning network, for anomaly detection and/or integrity assessment of assets such as flanges.

In some implementations, the computer system can identify different tasks for anomaly detection in assets such as flanges. The computer system can select a backbone model to deliver targeted information at the output of the anomaly detection ML model, based on the identified tasks. An example of the anomaly detection ML model can include convolutional neural networks and transformer based backbone models. The computer system can select backbone models based on the performance of the backbone models on the identified tasks. Example tasks for anomaly detection in assets such as flanges can include object detection, image classification, instance segmentation, and/or regression.

In some implementations, for the task of object detection, the output of the anomaly detection ML model can be bounding boxes for parts of interest of an asset whose integrity is to be assessed, for example, a flange. Example backbone models for object detection can include you-look-only-once (YOLO®), DETR with improved denoising anchor boxes (DINO®), or Faster Regions with CNN Features (R-CNN®).

In some implementations, for the task of image classification, the output of the anomaly detection ML model can be classification label for a given anomaly of an asset whose integrity is to be assessed, for example, a flange. Example backbone models for image classification can include Vision Transformer (ViT®), ConvNeXt®, or MobileNet®.

In some implementations, for the task of instance segmentation, the output of the anomaly detection ML model can be segmentation masks highlighting areas with anomalies for an asset whose integrity is to be assessed, for example, a flange. Example backbone models for instance segmentation can include Mask region-based convolutional neural network (Mask R-CNN®), segment anything model (SAM®), or YOLOX®.

In some implementations, for the task of regression, the output of the anomaly detection ML model can be numerical values associated with specific asset's properties and used to verify compliance of ASME norms. Example backbone models for regression can include both classic machine learning and deep learning models.

In some implementations, the computer system can train the selected backbone models using real RGB and thermal images of an asset whose integrity is to be assessed, for example, a flange, and/or synthetic RGB and thermal images of an asset type, for example, an asset type of flanges. The computer system can use transfer-learning, multi-task learning, continual learning, domain-adaptation, and/or style-transfer to train the selected backbone models.

At 210, the computer system provides the anomaly detection ML model's output to present qualitative and quantitative predictions, segmentation masks, bounding boxes, classification labels with confidence score, or regression values, as an informative report about the health condition of the analyzed asset, for example, a flange.

As described earlier, the computer system can use the anomaly detection ML model in 208 to detect different flange anomalies of an asset, for example, a flange, based on RGB images and thermal images of the asset. In some implementations, the computer system can use the anomaly detection ML model in 208 to determine if flange faces are aligned or misaligned. For example, grease, sand, and other deposits on a flange can confuse anomaly detection ML models that are trained on RGB images of the flange only, as deposits on the flange can cause visual confusion in the determination of alignment/misalignment of the flange face. The fusion of the thermal images with RGB images of the flange in an anomaly detection ML model can resolve the visual confusion as flange metal and deposits have different thermal coefficients and the prediction from the anomaly detection ML model can be more accurate. The tasks implemented by the anomaly detection ML model for determining whether flange faces are aligned can include image classification, object detection, and/or regression. For regression, a computer system can predict the actual misalignment between flange faces in millimeters and compare to ASME standards.

In some implementations, the computer system can use the anomaly detection ML model in 208 to determine if a flange's parts are complete or if there are missing parts, for example, missing bolts or missing nuts. In some cases, assets and flanges in the background of RGB images of a flange can degrade the performance of anomaly detection ML models that are trained to determine whether flanges are healthy or if they have missing elements. Therefore, the computer system can use thermal images in addition to RGB images as the input to the anomaly detection ML model in 208 to help the anomaly detection ML model focus on the inspection of the flange and ignore the other noisy background in the RGB images of the flange. The tasks implemented by the anomaly detection ML model for determining if a flange's parts are complete or if there are missing parts can include image classification or object detection.

In some implementations, the computer system can use the anomaly detection ML model in 208 to determine if a flange exhibits external corrosion. In some cases, external corrosion areas can exhibit different thermography rates than other areas of the flange, and the different thermography rates can help the anomaly detection ML model in 208 to predict if the flange or the pipe having the flange is intact or corroded. The tasks implemented by the anomaly detection ML model for determining if a flange exhibits external corrosion can include image classification, object detection, or instance segmentation.

In some implementations, the computer system can use the anomaly detection ML model in 208 to determine if a flange exhibits leakage and/or moisture. In case of steam/gas leakage, thermal images of the flange can show changes in thermal gradient. In case of moisture accumulation on the flange or its surrounding pipe, thermal images can indicate lower temperature rates in the area of moisture accumulation when compared to other areas of the flange. In some cases, leakage can be detected by anomaly detection ML models trained on thermal and RGB images. The tasks implemented by the anomaly detection ML model for determining if a flange exhibits leakage and/or moisture can include image classification, object detection, or instance segmentation.

In some implementations, the computer system can use the anomaly detection ML model in 208 to determine if flange gasket type is correct. In some cases, depending on the size of the flange or its surrounding pipe, correct type and size of gasket need to be used between the flange sides. By using RGB and thermal images, the rough geometric shape of the gasket can be captured by the anomaly detection ML model in 208 that can be trained to determine if the gasket is of appropriate type. The tasks implemented by the anomaly detection ML model for determining if flange gasket type is correct can include image classification, object detection, or regression.

In some implementations, the computer system can use the anomaly detection ML model in 208 to determine if flange gasket is healthy or damaged. In some cases, gaskets are manufactured to be squishable and flexible in order to absorb the pressure from the flange sides and prevent leaks. However, if flanges are assembled incorrectly, they could be damaged and cracked. By pointing the thermal and RGB cameras to the flange center, the thermal camera can detect discontinuity on the gasket rim corresponding to a gasket crack. The anomaly detection ML model in 208 then can analyze the input RGB and thermal images to predict whether the gasket is defective or healthy. The tasks implemented by the anomaly detection ML model for determining if flange gasket is healthy or damaged can include image classification or object detection. In some cases, gaskets related anomalies can be challenging anomaly to detect due to the presence of the bolts hindering the gasket view.

In some implementations, the addition of multiple asset views as well as data sources of RGB images and thermal images can enhance the performance of the anomaly detection ML models in 208.

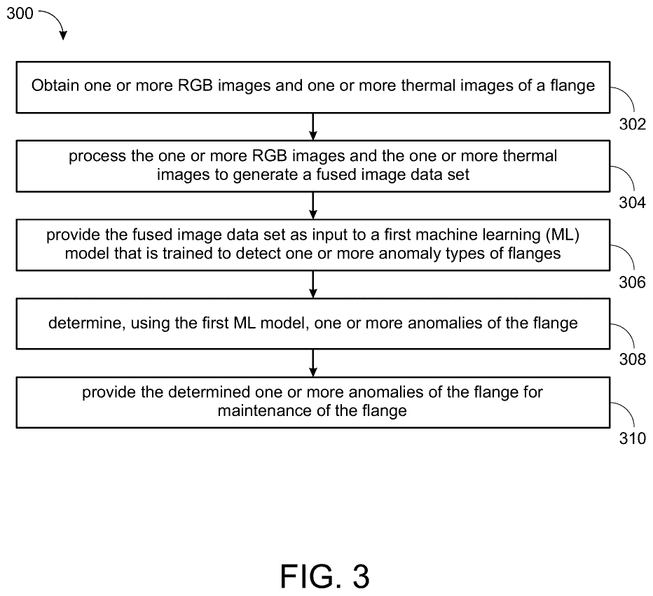

FIG. 3 illustrates an example process 300 for detecting asset anomalies. For convenience, process 300 will be described as being performed by a computer system having one or more computers located in one or more locations and programmed appropriately in accordance with this specification. An example of the computer system is the computer system 102 of FIG. 1 or the computing system 400 illustrated in FIG. 4.

At 302, a computer system obtains one or more RGB images and one or more thermal images of a flange.

At 304, the computer system processes the one or more RGB images and the one or more thermal images to generate a fused image data set.

At 306, the computer system provides the fused image data set as input to a first machine learning (ML) model that is trained to detect one or more anomaly types of flanges.

At 308, the computer system determines, using the first ML model, one or more anomalies of the flange.

At 310, the computer system provides the determined one or more anomalies of the flange for maintenance of the flange.

FIG. 4 is a block diagram of an example computer system 400 that can be used to provide computational functionalities associated with described algorithms, methods, functions, processes, flows, and procedures, according to some implementations of the present disclosure. In some implementations, the computer system performing process 200 or 300 can be the computer system 400, include the computer system 400, or the computer system performing process 200 or 300 can communicate with the computer system 400.

The illustrated computer 402 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 402 can include a Smart Embedded Management Agent (SEMA), such as a built-in ADLINK SEMA 2.2, and a video sync technology, such as Quick Sync Video technology supported by ADLINK MSDK+. In some examples, the computer 402 can include the MXE-5400 Series processor-based fanless embedded computer by ADLINK, though the computer 402 can take other forms or include other components.

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a high level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both), over the system bus. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs 412.

The service layer 413 can provide software services to the computer 402 and other components (whether illustrated or not) that are communicably coupled to the computer 402. The functionality of the computer 402 can be accessible for all service consumers using this service layer 413. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 can include an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and manipulate data to perform the operations of the computer 402, including operations using algorithms, methods, functions, processes, flows, and procedures as described in the present disclosure.

The computer 402 can also include a database 406 that can hold data for the computer 402 and other components connected to the network 430 (whether illustrated or not). For example, database 406 can be an in-memory, conventional, or a database storing data consistent with the present disclosure. In some implementations, the database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

An application 408 can be an algorithmic software engine providing functionality according to particular needs, desires, or particular implementations of the computer 402 and the described functionality. For example, an application 408 can serve as one or more components, modules, or applications 408. Multiple applications 408 can be implemented on the computer 402. Each application 408 can be internal or external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system including computer 402, with each computer 402 communicating over network 430. Further, the terms “client”, “user”, and other appropriate terminology can be used interchangeably without departing from the scope of the present disclosure. Moreover, the present disclosure contemplates that many users can use one computer 402 and one user can use multiple computers 402.

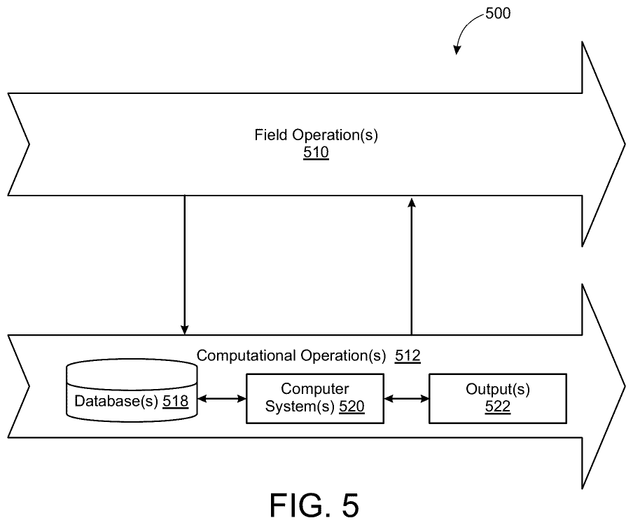

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser. Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### Embodiments

Embodiment 1: A computer-implemented method comprising obtaining one or more RGB images and one or more thermal images of a flange; processing the one or more RGB images and the one or more thermal images to generate a fused image data set; providing the fused image data set as input to a first machine learning (ML) model that is trained to detect one or more anomaly types of flanges; determining, using the first ML model, one or more anomalies of the flange; and providing the determined one or more anomalies of the flange for maintenance of the flange.

Embodiment 2: The computer-implemented method of embodiment 1, wherein processing the one or more RGB images and the one or more thermal images to generate the fused image data set comprises aligning one of the one or more RGB images with one of the one or more thermal images to a common coordinate system.

Embodiment 3: The computer-implemented method of embodiment 1 or 2, wherein determining the one or more anomalies of the flange comprises determining one or more backbone models in the first ML model based on the one or more anomaly types of the flange.

Embodiment 4: The computer-implemented method of embodiment 3, wherein the one or more backbone models comprise at least one backbone model for object detection, image classification, instance segmentation, or regression.

Embodiment 5: The computer-implemented method of any one of embodiments 1 to 4, wherein the one or more anomaly types of the flange comprise at least one of missing parts in the flange, misaligned faces of the flange, or external corrosion of the flange.

Embodiment 6: The computer-implemented method of any one of embodiments 1 to 5, further comprising: before determining the one or more anomalies of the flange using the first ML model, training the first ML model using a plurality of RGB images and a plurality of thermal images of a plurality of flanges.

Embodiment 7: The computer-implemented method of embodiment 6, wherein training the first ML model using the plurality of RGB images and the plurality of thermal images of the plurality of flanges comprises: extracting, using a second ML model, one or more features from the plurality of RGB images and the plurality of thermal images; generating a fused training image data set using the extracted one or more features; and training the first ML model based on the fused training image data set.

Embodiment 8: The computer-implemented method of any one of embodiments 1 to 7, wherein an output of the first ML model comprises at least one of one or more classification labels for the one or more anomaly types of the flange, one or more regression values for estimating a flange size, a bolt length, or a flange misalignment inclination, one or more object detection bounding boxes, or one or more segmentation masks for areas with anomalies.

Embodiment 9: The computer-implemented method of any one of embodiments 1 to 8, wherein the maintenance of the flange comprises at least one of replacing the flange, installing missing parts of the flange, adjusting an alignment between faces of the flange, or repairing the flange to prevent leakage from the flange.

Embodiment 10: A non-transitory computer-readable medium storing one or more instructions executable by a computer system to perform operations comprising: obtaining one or more RGB images and one or more thermal images of a flange; processing the one or more RGB images and the one or more thermal images to generate a fused image data set; providing the fused image data set as input to a first machine learning (ML) model that is trained to detect one or more anomaly types of flanges; determining, using the first ML model, one or more anomalies of the flange; and providing the determined one or more anomalies of the flange for maintenance of the flange.

Embodiment 11: The non-transitory computer-readable medium of embodiment 10, wherein processing the one or more RGB images and the one or more thermal images to generate the fused image data set comprises aligning one of the one or more RGB images with one of the one or more thermal images to a common coordinate system.

Embodiment 12: The non-transitory computer-readable medium of embodiment 10 or 11, wherein determining the one or more anomalies of the flange comprises determining one or more backbone models in the first ML model based on the one or more anomaly types of the flange.

Embodiment 13: The non-transitory computer-readable medium of embodiment 12, wherein the one or more backbone models comprise at least one backbone model for object detection, image classification, instance segmentation, or regression.

Embodiment 14: The non-transitory computer-readable medium of any one of embodiments 10 to 13, wherein the one or more anomaly types of the flange comprise at least one of missing parts in the flange, misaligned faces of the flange, or external corrosion of the flange.

Embodiment 15: The non-transitory computer-readable medium of any one of embodiments 10 to 14, wherein an output of the first ML model comprises at least one of one or more classification labels for the one or more anomaly types of the flange, one or more regression values for estimating a flange size, a bolt length, or a flange misalignment inclination, one or more object detection bounding boxes, or one or more segmentation masks for areas with anomalies.

Embodiment 16: A computer-implemented system, comprising one or more computers; and one or more computer memory devices interoperably coupled with the one or more computers and having tangible, non-transitory, machine-readable media storing one or more instructions that, when executed by the one or more computers, perform one or more operations comprising: obtaining one or more RGB images and one or more thermal images of a flange; processing the one or more RGB images and the one or more thermal images to generate a fused image data set; providing the fused image data set as input to a first machine learning (ML) model that is trained to detect one or more anomaly types of flanges; determining, using the first ML model, one or more anomalies of the flange; and providing the determined one or more anomalies of the flange for maintenance of the flange.

Embodiment 17: The computer-implemented system of embodiment 16, wherein determining the one or more anomalies of the flange comprises determining one or more backbone models in the first ML model based on the one or more anomaly types of the flange.

Embodiment 18: The computer-implemented system of embodiment 17, wherein the one or more backbone models comprise at least one backbone model for object detection, image classification, instance segmentation, or regression.

Embodiment 19: The computer-implemented system of any one of embodiments 16 to 18, wherein the one or more anomaly types of the flange comprise at least one of missing parts in the flange, misaligned faces of the flange, or external corrosion of the flange.

Embodiment 20: The computer-implemented system of any one of embodiments 16 to 19, wherein an output of the first ML model comprises at least one of one or more classification labels for the one or more anomaly types of the flange, one or more regression values for estimating a flange size, a bolt length, or a flange misalignment inclination, one or more object detection bounding boxes, or one or more segmentation masks for areas with anomalies.

We claim:

1. A computer-implemented method comprising:
obtaining one or more RGB images and one or more thermal images of a flange;
processing the one or more RGB images and the one or more thermal images to generate a fused image data set;
providing the fused image data set as input to a first machine learning (ML) model that is trained to detect one or more anomaly types of flanges;
determining, using the first ML model, one or more anomalies of the flange; and
providing the determined one or more anomalies of the flange for maintenance of the flange.

2. The computer-implemented method of claim 1, wherein processing the one or more RGB images and the one or more thermal images to generate the fused image data set comprises aligning one of the one or more RGB images with one of the one or more thermal images to a common coordinate system.

3. The computer-implemented method of claim 1, wherein determining the one or more anomalies of the flange comprises determining one or more backbone models in the first ML model based on the one or more anomaly types of the flange.

4. The computer-implemented method of claim 3, wherein the one or more backbone models comprise at least one backbone model for object detection, image classification, instance segmentation, or regression.

5. The computer-implemented method of claim 1, wherein the one or more anomaly types of the flange comprise at least one of missing parts in the flange, misaligned faces of the flange, or external corrosion of the flange.

6. The computer-implemented method of claim 1, further comprising:
before determining the one or more anomalies of the flange using the first ML model, training the first ML model using a plurality of RGB images and a plurality of thermal images of a plurality of flanges.

7. The computer-implemented method of claim 6, wherein training the first ML model using the plurality of RGB images and the plurality of thermal images of the plurality of flanges comprises:
extracting, using a second ML model, one or more features from the plurality of RGB images and the plurality of thermal images;
generating a fused training image data set using the extracted one or more features; and
training the first ML model based on the fused training image data set.

8. The computer-implemented method of claim 1, wherein an output of the first ML model comprises at least one of one or more classification labels for the one or more anomaly types of the flange, one or more regression values for estimating a flange size, a bolt length, or a flange misalignment inclination, one or more object detection bounding boxes, or one or more segmentation masks for areas with anomalies.

9. The computer-implemented method of claim 1, wherein the maintenance of the flange comprises at least one of replacing the flange, installing missing parts of the flange, adjusting an alignment between faces of the flange, or repairing the flange to prevent leakage from the flange.

10. A non-transitory computer-readable medium storing one or more instructions executable by a computer system to perform operations comprising:
obtaining one or more RGB images and one or more thermal images of a flange;
processing the one or more RGB images and the one or more thermal images to generate a fused image data set;
providing the fused image data set as input to a first machine learning (ML) model that is trained to detect one or more anomaly types of flanges;
determining, using the first ML model, one or more anomalies of the flange; and
providing the determined one or more anomalies of the flange for maintenance of the flange.

11. The non-transitory computer-readable medium of claim 10, wherein processing the one or more RGB images and the one or more thermal images to generate the fused image data set comprises aligning one of the one or more RGB images with one of the one or more thermal images to a common coordinate system.

12. The non-transitory computer-readable medium of claim 10, wherein determining the one or more anomalies of the flange comprises determining one or more backbone models in the first ML model based on the one or more anomaly types of the flange.

13. The non-transitory computer-readable medium of claim 12, wherein the one or more backbone models comprise at least one backbone model for object detection, image classification, instance segmentation, or regression.

14. The non-transitory computer-readable medium of claim 10, wherein the one or more anomaly types of the flange comprise at least one of missing parts in the flange, misaligned faces of the flange, or external corrosion of the flange.

15. The non-transitory computer-readable medium of claim 10, wherein an output of the first ML model comprises at least one of one or more classification labels for the one or more anomaly types of the flange, one or more regression values for estimating a flange size, a bolt length, or a flange misalignment inclination, one or more object detection bounding boxes, or one or more segmentation masks for areas with anomalies.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining one or more RGB images and one or more thermal images of a flange;
processing the one or more RGB images and the one or more thermal images to generate a fused image data set;
providing the fused image data set as input to a first machine learning (ML) model that is trained to detect one or more anomaly types of flanges;
determining, using the first ML model, one or more anomalies of the flange; and
providing the determined one or more anomalies of the flange for maintenance of the flange.

17. The computer-implemented system of claim 16, wherein determining the one or more anomalies of the flange comprises determining one or more backbone models in the first ML model based on the one or more anomaly types of the flange.

18. The computer-implemented system of claim 17, wherein the one or more backbone models comprise at least one backbone model for object detection, image classification, instance segmentation, or regression.

19. The computer-implemented system of claim 16, wherein the one or more anomaly types of the flange comprise at least one of missing parts in the flange, misaligned faces of the flange, or external corrosion of the flange.

20. The computer-implemented system of claim 16, wherein an output of the first ML model comprises at least one of one or more classification labels for the one or more anomaly types of the flange, one or more regression values for estimating a flange size, a bolt length, or a flange misalignment inclination, one or more object detection bounding boxes, or one or more segmentation masks for areas with anomalies.
